(19) United States
(12) Patent Application Publication
(10) Pub. No.: US 2009/0085543 A1
(43) Pub. Date: Apr. 2, 2009

(54) Variable Output Voltage Power Converter

(75) Inventors: James Sigamani, Quezon City (PH); Gordon Currie, Quezon City (PH)

Correspondence Address: HARNESS, DICKEY, & PIERCE, P.L.C, 7700 Bonhomme, Suite 400, ST. LOUIS, MO, 63105, US

(73) Assignee: Astec International Limited, Kwun Tong (HK)

(21) Appl. No.: 12/238,042

(22) Filed: Sep. 25, 2008

Related U.S. Application Data
(60) Provisional application No. 60/976,154, filed on Sep. 28, 2007.

(51) Int. Cl. G05F 1/00

(52) U.S. Cl. 323/282

(57) ABSTRACT

A method of generating at least a first voltage and a second voltage in a power converter including at least one DC-DC converter is disclosed. The method includes operating the DC-DC converter as a full-bridge converter to generate the first voltage and operating the DC-DC converter as a half-bridge converter to generate the second voltage. Power supplies including a DC-DC converter selectively configurable as a full bridge converter to provide a first DC voltage and as a half bridge converter to produce a second DC voltage and controller circuits for such configuration are also disclosed.

### CROSS-REFERENCE TO RELATED APPLICATIONS

This application claims the benefit of U.S. Provisional Application No. 60/976,154, filed on Sep. 28, 2007. The entire disclosure of the above application is incorporated herein by reference.

### FIELD

The present disclosure relates to variable output voltage power converters.

### BACKGROUND

This section provides background information related to the present disclosure which is not necessarily prior art.

Power supplies generally provide an output voltage with different characteristics than the voltage input to the power supply. Numerous types of power supplies exist with different characteristics, benefits, efficiencies and deficiencies. Variable output voltage power supplies are operable to provide at least two different output voltages from a single power supply unit. Various methods of achieving this variable output voltage are known.

FIG. 1 is a known variable voltage power supply, generally indicated by the reference numeral 100. The power supply 100 includes a pre-regulator circuit 102 and a full bridge resonant converter 104. The pre-regulator circuit is a buck converter. The details of the operation of a buck converter and a full bridge resonant converter are well known to those skilled in the art and will not be explained in detail herein. In operation, the pre-regulator circuit 102 receives a voltage input Vin and generates an intermediate voltage Vint. The intermediate voltage Vint is input to the full bridge resonant converter 104 and an output voltage Vout is generated.

The full bridge converter 104 is operated with a fixed duty ratio close to 50 percent and a fixed frequency. Each switch Q1-Q4 receives a pulse width modulation (PWM) signal having a substantially constant duty cycle and a substantially constant frequency. The turns ratio of a transformer 108 is fixed. Because of the fixed duty cycle and fixed transformer turns ratio of the full bridge converter, the output voltage will have a fixed relationship with the intermediate voltage Vint. The output voltage Vout is varied, therefore, by changing the value of the intermediate voltage Vint that is output from the pre-regulator circuit 102 and input to the full bridge converter 104, such as from 300 volts to 150 volts.

Variable voltage power supplies such as the one illustrated in FIG. 1 are often used to generate two different voltages. Commonly these voltages have a 2:1 relationship. By way of example, assume the power supply 100 is used to generate an output voltage Vout of 12 volts and 6 volts and has a transformer turns ratio of 25:1. To generate the 12 volt output, the intermediate voltage Vint is 300 volts. When the output voltage Vout is changed from 12 volts to 6 volts and the current output by the power supply 100 remains the same, the intermediate voltage Vint must be decreased by half, i.e. to 150 volts. The current output by the pre-regulator circuit 102 will, however, remain the same.

The losses in the pre-regulator 102 are largely based on the output current. When the current in the pre-regulator 102 and the full bridge 104 remains the same regardless of the output voltage, the magnitude of the losses remains roughly the same. For example, a typical buck converter may have an efficiency of 98.5%. For a 1200 watt converter, i.e. 12 volts at 100 amps, the current in the pre-regulator 102 is about 4 amps and the losses are about 18 watts. When 6 volt output is desired, the intermediate voltage Vint from the pre-regulator 102 is about 150 volts at 4 amps. The power output is decreased significantly, from 1200 watts to 600 watts. This constant power loss combined with reduced power output results in decreased efficiency. Thus, at 600 watts, the constant 18 watt losses result in an efficiency of about 97%.

### SUMMARY

This section provides a general summary of the disclosure, and is not a comprehensive disclosure of its full scope or all of its features.

According to one embodiment of the present disclosure, a variable output voltage DC-DC power supply includes a DC-DC converter selectively configurable as a full bridge converter for outputting a first DC voltage from the DC-DC converter and as a half bridge converter for outputting a second DC voltage from the DC-DC converter.

According to another aspect, a method of generating at least a first voltage and a second voltage in a power converter including at least one DC-DC converter is disclosed. The method includes operating the DC-DC converter as a full-bridge converter to generate the first voltage and operating the DC-DC converter as a half-bridge converter to generate the second voltage.

According to yet another aspect, a variable output voltage power supply includes a resonant converter having a plurality of switches selectively configurable as a full bridge converter for providing a first output voltage to a load and as a half bridge converter for providing a second output voltage to a load. The power supply also includes a pre-regulator circuit for providing a regulated voltage to the resonant converter. The pre-regulator circuit includes at least one switch. The power supply further includes a controller for controlling a duty cycle of the at least one switch according to the output voltage of the resonant converter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a circuit diagram of a known variable voltage power supply including a buck pre-regulator circuit and a full-bridge DC-DC converter.

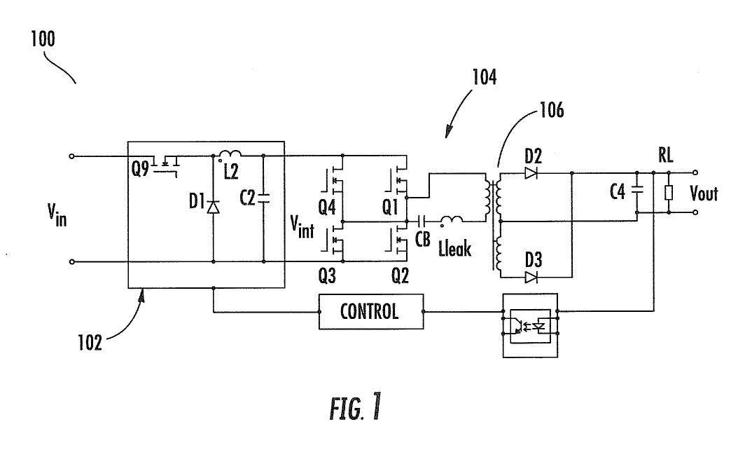

FIG. 2 is a circuit diagram of a variable voltage power supply according to one example embodiment including a buck pre-regulator and a DC-DC converter configurable as a half-bridge or full-bridge converter configured as a half-bridge converter.

FIG. 3 is a circuit diagram of another variable voltage power supply according to an example embodiment including a buck pre-regulator and a DC-DC converter configurable as a half-bridge or full-bridge converter.

FIG. 4 is a diagram of an example circuit for configuring the DC-DC converter of FIG. 2 as either a half-bridge or full-bridge converter.

FIG. 5 is a diagram of another example circuit for configuring a DC-DC converter of FIG. 3 as either a half-bridge or full-bridge converter.

FIG. 6 is a circuit diagram of a variable voltage power supply according to one example embodiment including a boost pre-regulator and a DC-DC converter configurable as a half-bridge or full-bridge converter.

FIG. 7 a circuit diagram of a variable voltage power supply according to one example embodiment including a buck-boost pre-regulator and a DC-DC converter configurable as a half-bridge or full-bridge converter.

FIG. 8 is a circuit diagram of yet another variable voltage power supply according to an example embodiment including a buck pre-regulator and a resonant DC-DC converter configurable as a half-bridge or full-bridge converter.

FIG. 9 is a circuit diagram of another variable voltage power supply according to an example embodiment including a buck pre-regulator and a hard switching DC-DC converter configurable as a half-bridge or full-bridge converter.

FIG. 10 is a diagram of an example circuit for configuring a DC-DC converter of FIGS. 8 or 9 as either a half-bridge or full-bridge converter.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

According to one aspect of the present disclosure, a method of generating at least a first voltage and a second voltage in a power converter having at least one DC-DC converter is disclosed. The method includes operating the DC-DC converter as a full-bridge converter to generate the first voltage and operating the DC-DC converter as a half-bridge converter to generate the second voltage.

In some embodiments, the DC-DC converter is operated with a substantially constant duty cycle when operated as a full bridge and as a half bridge converter. If the input voltage to the DC-DC converter is held substantially constant, the DC-DC converter, when configured as a half bridge converter, will generate a voltage approximately half the voltage generated when configured as a full bridge converter.

Example power converters capable of performing the method above will be discussed in further detail below. It should be understood, however, that other power converters can be employed without departing from the scope of this disclosure.

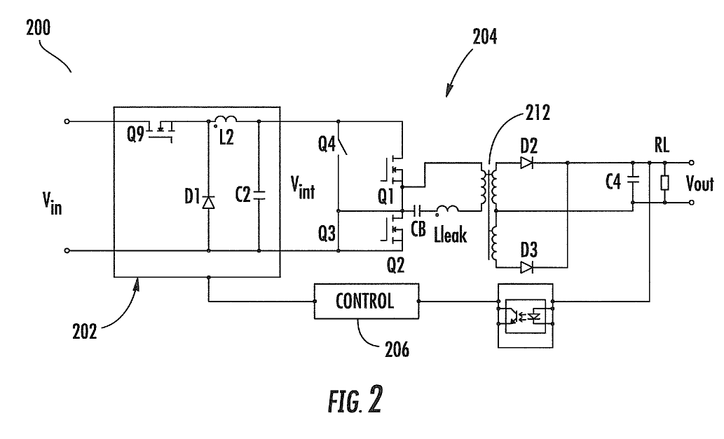

A variable voltage power supply 200 according to one example of the present disclosure is illustrated in FIG. 2. The power converter 200 includes a pre-regulator circuit 202 and a DC/DC converter 204. The pre-regulator circuit 202 is a buck converter. The pre-regulator circuit 202 receives an input voltage input Vin from a voltage source and generates an intermediate voltage Vint. The pre-regulator is controlled by a controller 206, which may be an analog controller, a digital controller or a combination thereof. When the controller is a digital controller, it may be, for example, a microprocessor, DSP, ASIC, etc. When the pre-regulator circuit 202 is a buck converter, as in FIG. 2, the intermediate voltage Vint will be less than the input voltage Vin of the pre-regulator circuit. The intermediate voltage is input to the converter 204 and an output voltage Vout is generated. The turns ratio of the transformer 212 is fixed. The converter 204 is operated by a controller with a fixed duty ratio close to 50 percent and at a substantially fixed frequency. The controller may be an analog controller, a digital controller, or a combination thereof. The controller for operating the converter 204 may be the controller 206 or a separate controller.

The output voltage Vout of the power supply 200 can be varied by selectively configuring the converter 204 as either a full bridge converter or a half bridge converter. The converter 204 includes four switches, Q1-Q4. In the full bridge configuration, all four switches Q1-Q4 operate in the manner of full bridge converters as known to those skilled in the art. The power supply 200 is illustrated in FIG. 2 in the half bridge configuration. Switch Q3 is shorted while switch Q4 is held open. Switches Q1 and Q2 operate as the two switches of a half bridge converter. The operation of a half bridge converter is well known to those skilled in the art and will not be discussed in detail.

While the switches in the various figures of this disclosure are illustrated as MOSFETs, it should be understood that other types of switches can be used without departing from the scope of this disclosure.

When the converter 204 is configured to operate as a full bridge converter, the output voltage Vout is the intermediate voltage Vint divided by the turns ratio of the transformer 212. When the converter is configured to operate as a half bridge converter, the output voltage Vout is the intermediate voltage Vint divided by twice the turns ratio of the transformer 212. If the intermediate voltage Vint and the turns ratio are substantially constant, the output voltage Vout in the half bridge configuration is approximately half the full bridge configuration output voltage Vout.

Although the intermediate voltage Vint is held substantially constant in the full bridge configuration and the half bridge configuration, the current output from the pre-regulator 202 is not. In the half bridge configuration, the current output from the pre-regulator 202 is approximately half of the full bridge configuration pre-regulator current. Because the losses in the pre-regulator 202 are largely determined by, and proportional to, the pre-regulator output current 202, the pre-regulator 202 operates with smaller losses when the converter 204 is configured as a half bridge converter. This, therefore, results in increased efficiency over other variable output voltage converters.

An example power converter 200 may provide a 12 volt and a 6 volt converter output both at 100 amps. The turns ratio of the transformer 212 is 25:1. The intermediate voltage Vint is 300 volts. As mentioned above, a typical buck converter may have an efficiency of 98.5%. Thus when the converter 204 is set to operate as a full bridge converter, the current in the pre-regulator 202 is about 4 amps and the losses are about 18 watts. When 6 volt output is desired, the converter 204 is configured as a half bridge. The pre-regulator 202 continues to output a 300 volt intermediate voltage Vint. The output current of the pre-regulator, however, is 2 amps. Thus, the pre-regulator 202 is operating at half the current load as it is when the converter 204 is configured as a full bridge converter. Typical buck converter efficiency at half load can be about 99%.

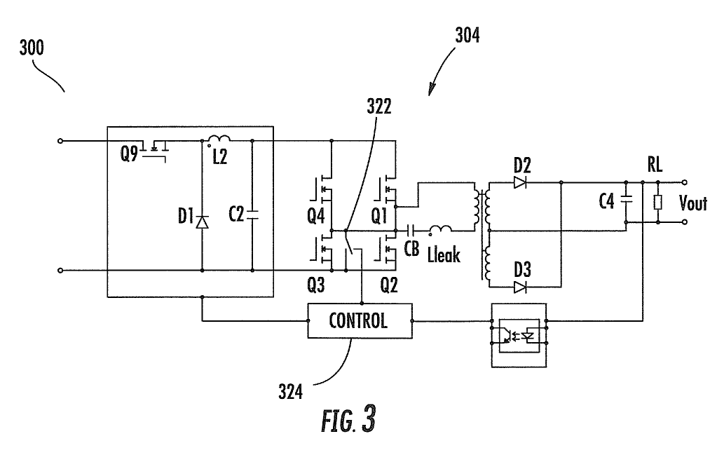

FIG. 3 illustrates another example variable voltage power supply 300. The power supply includes a DC-DC converter 304. The converter 304 includes four switches Q1-Q4. The converter 304 operates as discussed above with respect to the circuit in FIG. 2. However, the power supply 300 also includes an electromagnetic relay 322 coupled across the switch Q3 that can be opened and closed by a control circuit 324 to short circuit the switch Q3. Similar to the circuit in FIG. 2, when the converter 304 is configured as a half bridge converter, the control circuit 324 causes the relay 322 to close and short the switch Q3, while the switch Q4 is held open. The relay 322 is more efficient than switch Q3. Therefore, shorting around the switch Q3 via the relay 322 can increase the efficiency of the converter 304 over the circuit of FIG. 2.

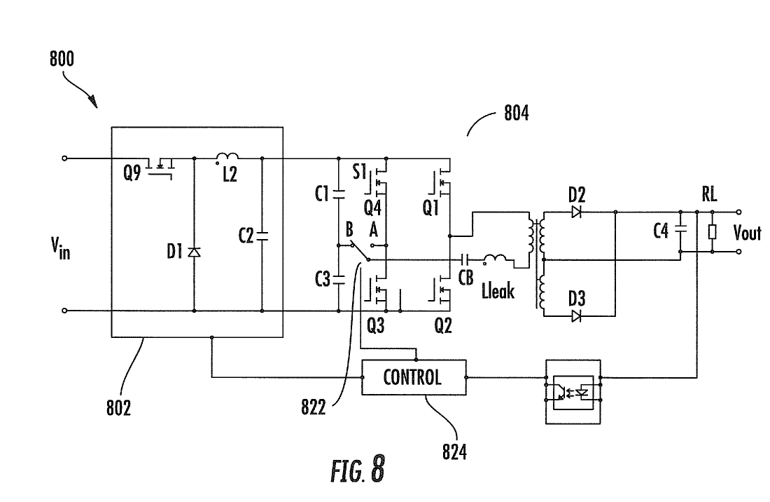

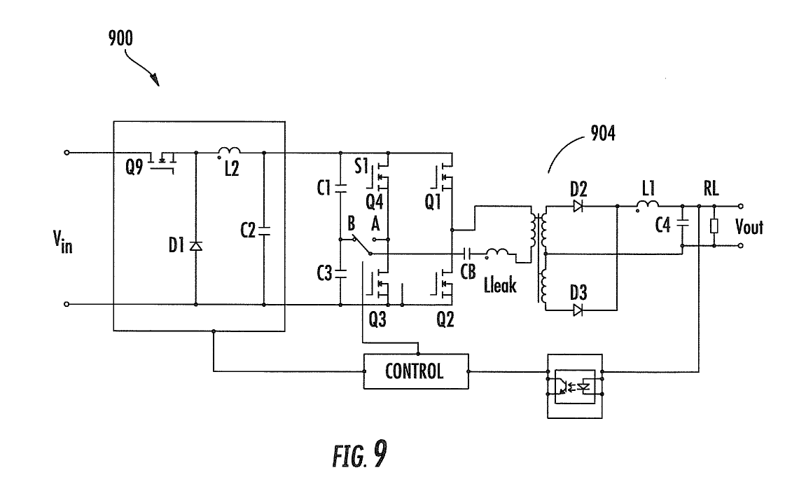

FIGS. 8 and 9 illustrate two additional example variable voltage power supplies 800 and 900. The power supply 800 includes a pre-regulator circuit 802 and a DC-DC converter 804. The converter 304 includes four switches Q1-Q4. The converter 804 operates in a manner similar to the circuit in FIG. 2. However, the power supply 800 includes an electromagnetic relay 822 which can be switched between two positions A and B by a control circuit 824. When the relay 822 is in position A, the converter 804 operates as a resonant full bridge converter. When the relay 822 is placed in position B, the converter 804 operates as a resonant half bridge converter. The power supply 900 is similar to the power supply 800 except that the converter 904 is not a resonant converter. More specifically, the converter 904 is an open loop, hard switching converter.

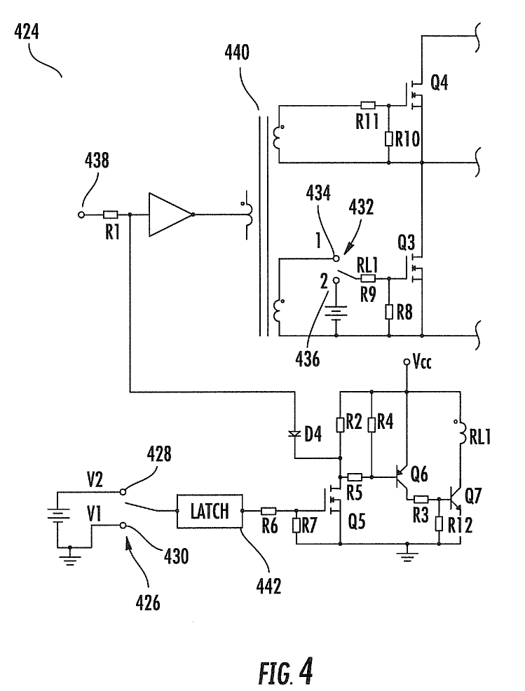

FIG. 4 illustrates a portion of an example of a control circuit 424 for selectively configuring a converter, such as converter 204, as either a full bridge converter or a half bridge converter. The control circuit 424 includes an output voltage selection switch 426. When the voltage selection switch 426 is connected to the first voltage position 430, the circuit causes a relay contact 432 to be in a first relay position 434. Drive pulses provided by a controller for the switches, Q3 and Q4, are received at drive input 438 and allowed to travel to the switches Q3 and Q4 through a drive transformer 440. Thus, the converter 204 will operate as a full bridge converter including four switches, Q1-Q4. The control circuit 424 also includes a latch 442 that prevents a change from full bridge to half bridge, or vice versa, while the power supply 200 is operating.

When the output voltage selection switch 426 is connected to the second voltage position 428, the control circuit 424 configures the converter 204 as a half bridge power converter. Placing the voltage selection switch 426 in the second voltage position 428 enables switches Q5-Q7. The relay contact 432 is moved to a second position 436. As a result, switch Q3 will be continuously enabled, i.e. a continuously closed, while switch Q4 will be continuously held open. This results in the converter 204 being configured as a half bridge converter as illustrated in FIG. 2.

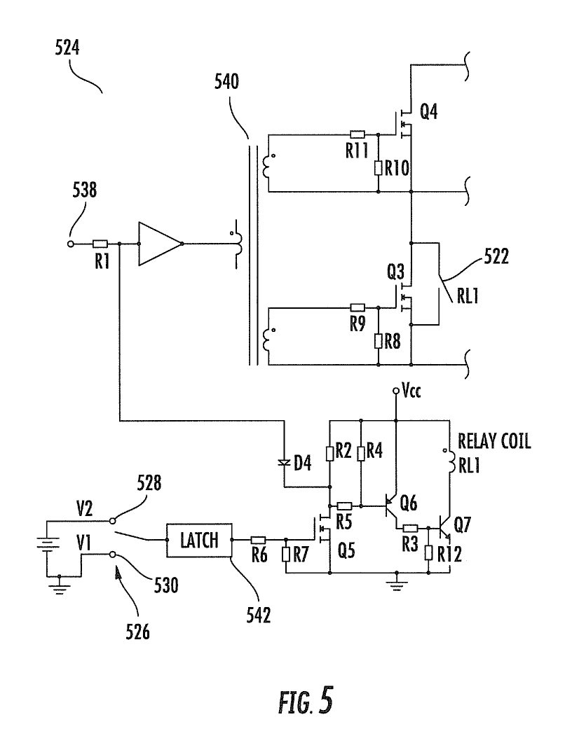

FIG. 5 illustrates a portion of another control circuit 524 for selectively configuring the converter, such as the converter 304, as either a full bridge converter or a half bridge converter. The control circuit 524 includes an output voltage selection switch 526. When the voltage selection switch is connected to the first voltage position 530, the circuit causes a relay 522 to open. Drive pulses provided by a controller for the switches Q3 and Q4, are received at drive input 538 and allowed to travel to the switches Q3 and Q4 through a drive transformer 540. Thus, the converter 304 will operate as a full bridge converter including four switches, Q1-Q4. The control circuit 524 also includes a latch 542 that prevents a change from full bridge to half bridge, or vice versa, while the power converter 304 is operating.

When the output voltage selection switch 526 is connected to the second voltage position 528, the control circuit 524 configures the power converter 304 as a half bridge power converter. Placing the voltage selection switch in the second voltage position enables switches Q5-Q7. This causes the relay 522 to close, while switch Q4 is held continuously held open. Closing the relay 522 creates a short circuit around the switch Q3. This results in the converter 304 being configured as a half bridge converter.

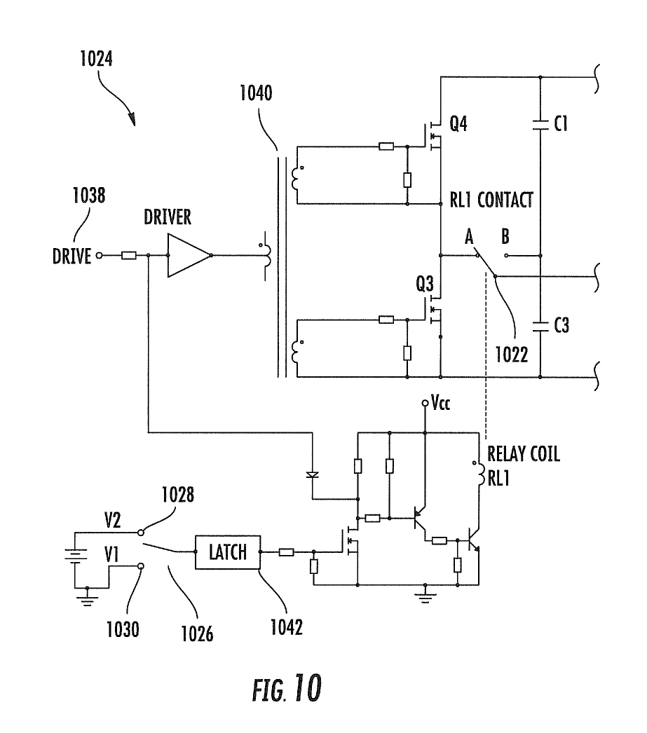

FIG. 10 illustrates a portion of yet another control circuit 1024 for selectively configuring the converter, such as converters 804 and 904, as either a full bridge converter or a half bridge converter. The control circuit 1024 includes an output voltage selection switch 1026. When the voltage selection switch is connected to the first voltage position 1030, the circuit keeps relay 1022 in position A. Drive pulses provided by a controller for the switches Q3 and Q4, are received at drive input 1038 and allowed to travel to the switches Q3 and Q4 through a drive transformer 1040. Thus, the converter 804 or 904 will operate as a full bridge converter including four switches, Q1-Q4. The control circuit 1024 also includes a latch 1042 that prevents a change from full bridge to half bridge, or vice versa, while the power converter 804 or 904 is operating.

When the output voltage selection switch 1026 is connected to the second voltage position 1028, the control circuit 1024 configures the power converter 804 or 904 as a half bridge power converter. Placing the voltage selection switch in the second voltage position enables switches Q5-Q7. This causes the relay 1022 to move to position B. This results in the converter 804 or 904 being configured as a half bridge converter.

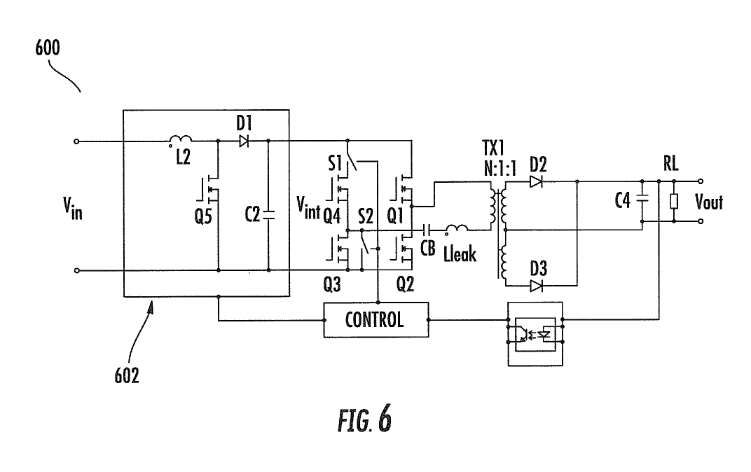

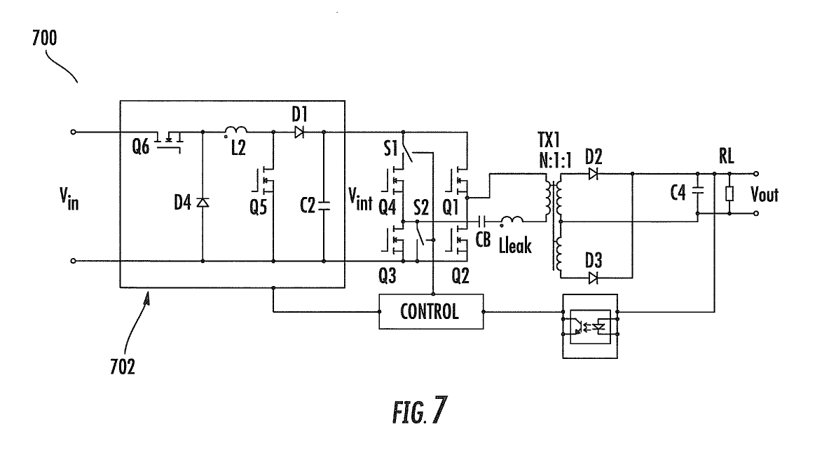

Although the pre-regulator circuit illustrated in the previous embodiments is a buck converter, this disclosure is equally applicable to different converter topologies. FIG. 6 illustrates an example power supply 600 that includes a pre-regulator circuit 602 which is a boost converter. The intermediate voltage Vint generated by the boost pre-regulator circuit will be greater than the input voltage Vin of the boost pre-regulator circuit. Similarly, FIG. 7 illustrates a power supply 700 that includes a pre-regulator circuit 702 that is a buck-boost converter. The intermediate voltage Vint generated by the buck-boost pre-regulator circuit can be greater than, less than, or the same as the input voltage Vin depending upon the control signals driving the buck-boost pre-regulator. The buck, boost, and buck-boost converters are well known to those skilled in the art and details of the operation of such converters are omitted for brevity. The remainder of the power supplies 600 and 700 operate in the manner previously discussed in this disclosure. Further repetition of these details of operation is, therefore, omitted.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed:

1. A variable output voltage DC-DC power supply, the power supply comprising a DC-DC converter selectively configurable as a full bridge converter for outputting a first DC voltage from the DC-DC converter and as a half bridge converter for outputting a second DC voltage from the DC-DC converter.

2. The power supply of claim 1 wherein the DC-DC converter is a resonant converter.

3. The power supply of claim 2 wherein the second DC voltage is about half of the first DC voltage.

4. The power supply of claim 3 wherein the first DC voltage is about 12 volts and the second DC voltage is about 6 volts.

5. The power supply of claim 1 wherein the DC-DC converter is configured to operate in open loop with a substantially constant duty cycle.

6. The power supply of claim 1 wherein the DC-DC converter includes four MOSFET switches selectively configurable for use in the full bridge converter.

7. The power supply of claim 6 wherein the DC-DC converter is configured to hold closed one of the MOSFET switches and hold open another one of the MOSFET switches when the DC-DC converter is selectively configured as the half bridge converter.

8. The power supply of claim 1 wherein the DC-DC converter includes a plurality of MOSFET switches and at least one relay operable to short circuit one of the MOSFET switches when the DC-DC converter is selectively configured as the half bridge converter.

9. The power supply of claim 8 wherein the relay is an electromagnetic relay.

10. The power supply of claim 1 further comprising a pre-regulator circuit for providing a regulated voltage to an input of the DC-DC converter.

11. The power supply of claim 10 wherein the pre-regulator circuit is a buck converter.

12. The power supply of claim 10 further comprising a controller configured to control the regulated voltage provided by the pre-regulator circuit according to the output voltage of the DC-DC converter.

13. The power supply of claim 1 further comprising a switch for selectively configuring the DC-DC converter as one of the full bridge converter and the half bridge converter.

14. The power supply of claim 1 wherein the DC-DC converter is a hard switching converter.

15. A method of generating at least a first voltage and a second voltage in a power converter including at least one DC-DC converter, the method comprising:
operating the DC-DC converter as a full-bridge converter to generate the first voltage; and
operating the DC-DC converter as a half-bridge converter to generate the second voltage.

16. The method of claim 15 further comprising powering down the DC-DC converter before changing operation of the DC-DC converter.

17. The method of claim 15 wherein operating including operating the DC-DC converter with a substantially constant duty cycle.

18. The method of claim 15 wherein operating includes receiving a substantially constant voltage input to the DC-DC converter.

19. A variable output voltage power supply comprising:
a converter having a plurality of switches selectively configurable as a full bridge converter for providing a first output voltage to a load and as a half bridge converter for providing a second output voltage to a load,
a pre-regulator circuit for providing a regulated voltage to the converter, the pre-regulator circuit including at least one switch; and
a controller for controlling a duty cycle of the at least one switch according to the output voltage of the converter.

20. The power supply of claim 19 wherein the converter is a resonant converter.

21. The power supply of claim 19 wherein the converter is a hard switching converter.

22. The power supply of claim 19 wherein the converter is configured to operate in an open loop.

23. The power supply of claim 22 wherein the pre-regulator circuit is a buck converter.

24. The power supply of claim 23 wherein the regulated voltage provided to the converter when the plurality of switches are configured as the full bridge converter is substantially the same as the regulated voltage provided to the converter when the plurality of switches are configured as the half bridge converter.
